(19) United States
(12) Patent Application Publication
(10) Pub. No.: US 2007/0100518 A1
(43) Pub. Date: May 3, 2007

(54) Method and System For Fluid Condition Monitoring

(76) Inventor: Johnny G. Cooper, Grand Blanc, MI (US)

Correspondence Address: ARTZ & ARTZ, P.C., 28333 TELEGRAPH RD., SUITE 250, SOUTHFIELD, MI, 48034, US

(21) Appl. No.: 11/555,012

(22) Filed: Oct. 31, 2006

Related U.S. Application Data
(60) Provisional application No. 60/596,939, filed on Oct. 31, 2005.

(51) Int. Cl. G01M 17/00; G06F 19/00

(52) U.S. Cl. 701/29; 701/33

(57) ABSTRACT

The present invention discloses a fluid condition detection system for monitoring a working fluid. The fluid condition detection system includes a fluid sensor, a sensor control processor and a condition data comparison processor. The fluid sensor is placed within a fluid of interest and controlled by the sensor control processor. The sensor control processor generates a fluid condition signal that is then processed by the condition data comparison processor, which generates a second fluid data set. The condition data comparison processor compares the second fluid data set with a first fluid data set and generates a fluid condition status, whereby the fluid condition status may be communicated to a user, a service technician or a fleet maintenance operator. A method of operating a fluid condition detection system is also provided.

### CROSS REFERENCE TO RELATED APPLICATIONS

The present application relates back to and incorporates by reference provisional patent-application Ser. No. 60/596,939 filed on Oct. 31, 2005.

### TECHNICAL FIELD

The present invention relates generally to a maintenance system for monitoring the condition of fluid, and more particularly to a maintenance system for monitoring the service condition of vehicle operating fluid, i.e., engine oil, with notification to a user, service technician or fleet maintenance system, including a method thereof.

### BACKGROUND OF THE INVENTION

Users, service technicians and fleet maintenance operators are highly conscious of balancing preventive maintenance costs and fleet operational readiness with repair and replacement costs. While cost effective fleet management and readiness requirements demand the practice of preventive maintenance, some of these practices are based, for lack of individual vehicle information, on potentially overly conservative regimens derived from broad statistical studies. An example of such a practice is manufacturers' recommendations relating to changes of motor oil. A change of motor oil costs money and removes a vehicle from service. While frequent changes of motor oil doubtless extend the service life of a vehicle and are, up to a point, economically advisable, they can become wasteful and uneconomic if excessively frequent or premature of actual oil degradation. Moreover, such changes of motor oil may also be missed thereby decreasing the service life of a vehicle because of a failure to timely notify the user, service technician or fleet management system when the motor oil is used well beyond the manufacturers' recommended use. Lastly, motor oil may prematurely degrade prior to manufacturers' recommended use by environmental and corrosive conditions caused by time and or engine use, which accordingly will also decrease the service life of a motor.

Changes of motor oil are necessitated by the fact that motor oil loses its lubricating properties with use or time. With loss of adequate lubrication an engine is exposed to wear and damage. The degree, and character, of motor oil degradation is related to a number of factors, including temperature cycling of the lubricant that relates to oxidation of the oil, and the possibility of the addition of foreign material to the oil. Manufacturers' recommended oil change schedules are typically based on a conservatively short estimate of the useful life of the oil, e.g. 3000 miles, 7500 miles, etc.

U.S. Pat. No. 5,987,976 reports the practice of modifying estimates of engine oil useful life by taking into account the conditions under which an engine operates. The '976 patent asserts that a shortcoming of such a method is that it does not indicate the condition of the motor oil at any given moment. Put another way, the method is a refinement of statistical methodology and is handicapped by the use of operator impressions of “operating conditions” (e.g. vehicle loads, prevailing air temperature, etc.), and the lack of quantifiable inputs relating to specific trucks.

U.S. Pat. No. 6,513,368 reports a method of monitoring motor oil during engine operation in implementing a purported economically efficient oil change regimen. The '368 patent effectively measure a set of variables relating to operation of the internal combustion engine, which serve as proxy variables for estimating the remaining life of the lubricating oil. However, while the '976 and the '368 patents measure engine conditions and engine variables to estimate oil life in predicting remaining oil life, they both fail to measure the degradation of oil life or account for the adequacy of using the degrading oil in the engine.

Accordingly, it would be advantageous to measure the degradation of fluid, i.e., oil, life or account for the adequacy of using the degrading fluid in the engine by providing a system for monitoring the fluid condition. Moreover, it would be advantageous to provide a system that monitors and reports current fluid deterioration to a user, service technician or fleet management system. Therefore a novel system and method of monitoring the condition of a fluid is provided below.

U.S. Pat. No. 6,904,786 entitled “Method And Apparatus For Characterizing Materials By Using A Mechanical Resonator”, which is incorporated by reference herein, provides a fluid sensor that may be utilized to advantage for the novel system presented below. U.S. Pat. No. 6,873,916 entitled “Application Specific Integrated Circuitry For Controlling Analysis Of A Fluid”, which is incorporated by reference herein, provides a circuit for determining characteristics of a fluid using the fluid sensor that may be utilized to advantage for the novel system presented below.

### SUMMARY OF THE INVENTION

In accordance with the above mentioned, a fluid condition detection system for monitoring a working fluid is provided. The fluid condition detection system includes a fluid sensor, a sensor control processor and a condition data comparison processor. The fluid sensor is selectively placed within a fluid of interest and controlled by the sensor control processor. The sensor control processor generates a fluid condition signal that is then processed by the condition data comparison processor, which generates a fluid data set. The condition data comparison processor compares the fluid data set with a prior fluid data set and generates a fluid condition status, whereby the fluid condition status may be communicated to a user, a service technician or a fleet maintenance operator. A method of operating a fluid condition detection system is also provided.

Additional effects, features and advantages will be apparent in the written description that follows.

### BRIEF DESCRIPTION OF THE DRAWINGS

For a more complete understanding of this invention, reference may be made to the inventive aspects illustrated in greater detail in the accompanying drawings and described below.

FIG. 1 illustrates a system for oil condition sensing, in accordance with an embodiment of the present invention.

FIG. 2 illustrates a fluid sensing system used in an exemplary automobile, in accordance with the embodiment of the present invention.

FIG. 3 illustrates a local machine user interface being used to advantage in accordance with the embodiment of the present invention.

FIG. 4 illustrates a condition data comparison processor being used to advantage in accordance with the embodiment of the present invention.

FIG. 5 illustrates a diagram for receiving and recording the fluid data received into fluid data sets, in accordance with the embodiment of the present invention.

FIG. 6 is a flow chart diagram depicting method performed in a comparison processor in comparing different fluid data sets, in accordance with one embodiment of the present invention.

### DETAILED DESCRIPTION OF THE PREFERRED EMBODIMENT

The present invention provides a system for monitoring the current condition of a working fluid, e.g., motor oil, and provides communication of the current condition of the fluid to a user, a service technician or a fleet management system. The system further quantifies the current condition of the fluid or motor oil into bands of acceptable or unacceptable degradation ranges that may be used to advantage by the user, the service technician or the fleet management system. Also in one aspect of the invention, the system may provide an usable remaining life estimation based upon the current condition of the physical motor oil, and possibly taking into consideration other estimated conditions that affect oil degradation, e.g. mileage, oil age, temperature, oil shear or non-use just to mention a few measurable variables. Further, although the present invention will be explained relative to motor oil as the working fluid, it is to be understood that the present invention can be used relative to virtually all fluids of an automobile or other vehicle, such as hydraulic fluids, brake fluids, transmission fluids, air conditioning fluids, and the like.

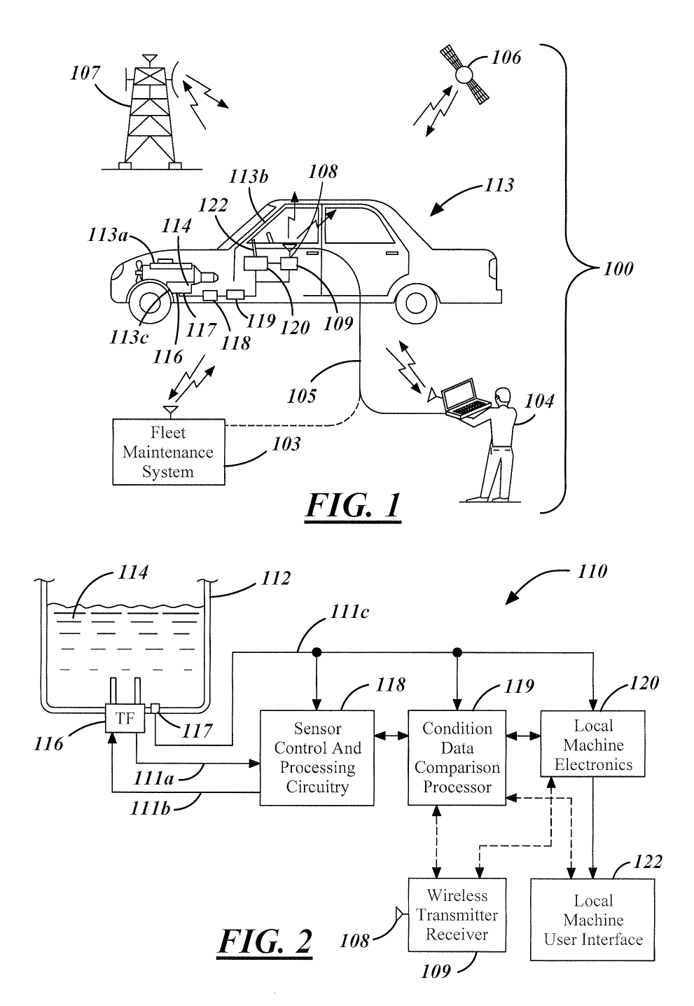

FIG. 1 illustrates a system for oil condition sensing 100, in accordance with an embodiment of the present invention. The system 100 includes a subject automobile 113, a local machine user interface 122, a condition data comparison processor 119, a sensor or tuning fork 116, and a sensor control processor 118, discussed below. The system 100 may also include a wireless transmitter/receiver 109 and antenna 108 that may communicate acquired fluid data (not shown) to remote locations or other information systems. For example, the acquired fluid data may be sent to a fleet maintenance system 103 or to a service technicians computer 104 for subsequent processing in accordance with the present invention. The fluid data may also be transmitted via a signal by a wire 105 or directed to a local machine user interface 122 for using to advantage. The fluid data signal may also be transmitted by way of ground wires (not shown), transmission tower 107, or even by satellite 106. It is to be understood that the communication/transfer modes of digital and/or analog information is well understood in the art, accordingly this novel invention incorporates any and all modes of communication necessary for the implementation of the novel aspect taught herein. In this regard, communication may be by BlueTooth, 802, CDMA, tethered U.S.B, satellite, Wi-Fi, WiMAX or physical data link, without limitation.

The condition data comparison processor 119, which will be described in detail below, is an element of the present system 100. While the condition data comparison processor 119 has been included as a component within the automobile 113 so that the condition of oil or other fluids may be directly outputted to an occupant of the automobile 113, it is recognized that the condition comparison processor 119 may also reside in the sensor 116, the fleet maintenance system 103, the service technician computer 104 or in any other computational device suitable for use with the present invention.

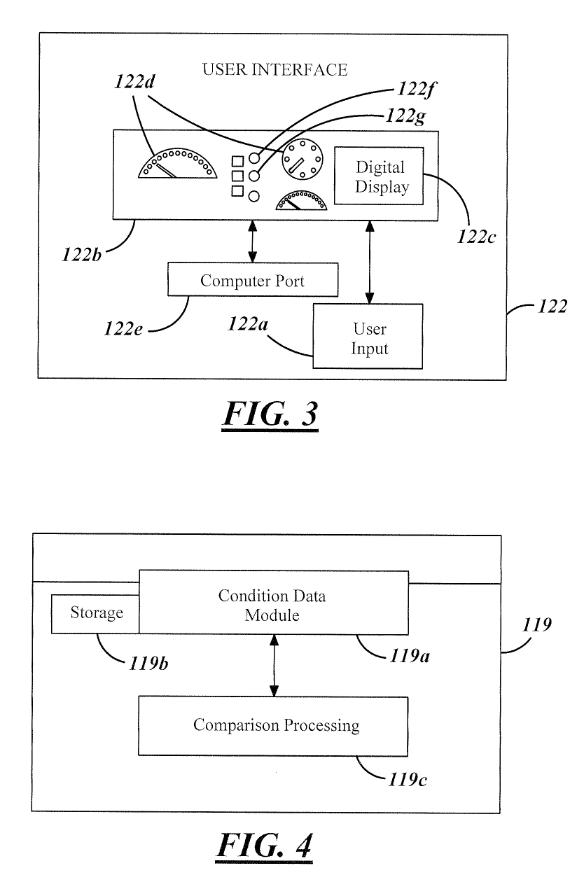

One type of computational device that may be suitably used to advantage in implementing the condition data comparison processor 119 is a Azentek mobile computer provided by Azentek located in Grand Blanc, Mich. The Azentek mobile computer may complement the local machine user interface, or supplement the fleet maintenance system 103 or service technician computer 104 in determining the condition of a fluid (discussed below). The Azentek computer includes a fluid management solution for engine application so that automobile owner may be notified of the current fluid condition in various ways. The Azentek computer receives information from a sensing device, such as the tuning fork and processor (discussed below), and processes the information using the condition data comparison processor 119 thereby providing fluid condition information to the operator, service technician or fleet manager required for proper maintenance and servicing of the automobile 113. Notification to the operator, service technician or fleet manager may be accomplished in multiple ways: first, notification data may be by a light 122f or audible indicator 122g on the user interface 122 as shown in FIG. 3; second, notification data may be saved, collected and then downloaded to a service technician computer 104 or fleet maintenance system 103 at a later date; or third, notification data may be cashed to the fleet maintenance system 103 or equivalence system. It is recognized that the implementation of the notification may also be accomplished by additional ways or various combinations of the above mentioned and is not to be limited in scope.

Returning to FIG. 1, the automobile 113 has an engine 113a and a display dashboard 113b. The engine 113a will include an oil pan 113c. The oil pan 113c will have a tuning fork 116 inserted therein. The tuning fork 116 may be inserted at any location within the oil pan 113c, so long as the tuning fork tine is sufficiently in contact with the fluid under-test 114. The fluid under-test 114 is this embodiment is oil contained within the oil pan 113c. It is recognized that the fluid under-test may be any other operating fluid, such as, without limitation, hydraulic fluid, brake fluid, or air-conditioning fluid.

Optionally, the tuning fork 116 may be utilized to advantage by placing it in the fluid reservoir or elsewhere within the fluid flow path.

The tuning fork 116 is shown coupled to the sensor control processor 118, in this embodiment. Optionally, the tuning fork 116 may be an integrated electronic package that includes a sensor control processor, a condition data comparison processor and or a wireless transmitter/receiver.

The sensor control processor 118 is in turn coupled to condition data comparison processor 119 which is then coupled to the local machine electronics 120 that may be provided by the automobile 113 manufacturer. In operation, the tuning fork 116 will be contained within the fluid flow path or the fluid reservoir of the oil pan 113c and the sensor control processor will be integral with the tuning fork 116. In another embodiment, the sensor control processor 118 will be located close to the tuning fork 116, but not integral therewith. In still another embodiment, the sensor control processor will be mounted to a printed circuit board that is coupled to the automobile 113 (i.e., either with other local electronics or separate there from). Likewise the condition data comparison processor 119 may be integral with the sensor control processor 118 and/or the tuning fork 116, or it may be a separate component as shown or embodied in a different system as noted above.

Irrespective of its physical installation, the condition data comparison processor 119 may continuously or periodically receive data from the sensor control processor 118, which monitors the condition of the fluid under-test 114 and provide data to the sensor control processor 118. The condition data comparison processor 119 may therefore continuously or periodically communicate data back to the local machine electronics 120 which then provides the information to the local machine user interface 122. In another embodiment, as suggested above, the monitoring may only be during a specific duration, at predetermined times, or on-demand (i.e., per user/technician request or query).

As shown in FIG. 3, the local machine user interface 122 will be provided in the form of a display dashboard 113b that provides a visual 122f, an audible 122g, or a combination of visual and audible information to a driver or user of the automobile 113. In this manner, the driver (or technician) of the automobile 113 will be informed of the condition of the fluid under-test 114 during the use/service of the automobile 113. In one example, when the fluid under-test, e.g., engine oil, becomes degraded to a level that may require replacement, the local machine user interface 122 will display an indication to the user of the automobile 113 by way of the display dashboard 113b. Optionally, the display dashboard may also include a computer port 122e in which a service technician computer 104 or a personal computer, such as the Azentek computer, may be connected to receive the data.

FIG. 2 illustrates a fluid sensing system 110 used in the exemplary automobile 113, in accordance with the embodiment of the present invention. The fluid sensing system 110 utilizes the tuning fork 116 which can be placed into a fluid under-test 114. In simplest terms, the fluid may reside in a container 112. The container 112 can take on any form, such as a closed form, open form, pressurized form, etc., so long as it can hold the desired fluid. In this embodiment, the fluid under-test 114 is a low viscosity non-synthetic engine oil, such as 10W-40. As shown, the tuning fork 116 is closely coupled to a temperature sensor 117 that provides feedback to electronics of the fluid sensing system 110. For example, the temperature sensor 117 may be a resistance temperature detector (RTD), or any other suitable temperature-monitoring device. A sensor control and processing circuit 118 provides stimulus (e.g., such as an applied frequency) via connection 111b to the tuning fork 116. The response from the tuning fork 116 is received via connection 111a back to the sensor control and processing circuit 118. The response is an analog response of the tuning fork 116.

In one embodiment, the temperature sensor 117 is further interfaced via connection 111c to the sensor control and processing circuit 118. Optionally, the connection 111c will also provide temperature data back to the local machine electronics 120 or the condition data comparison processor 119. The connections 111 are provided to illustrate a functional interconnect between the tuning fork 116 and the temperature sensor 117, although it should be understood that fewer or more physical wires or connections may be used to complete the electrical interconnections. The condition data comparison processor 119 or the local machine electrics 120 may be, for example, electronics of a machine containing the fluid under-test 114. In the automobile industry, specialized computers and electronic are commonly provided as native to an automobile, and such electronics and associated software operate to control and receive feedback from the various systems of the automobile. Accordingly, it is envisioned that the local machine electronics 120 or the condition data comparison processor 119 may also make use of temperature data.

The temperature sensor 117 therefore will provide temperature data for the fluid under-test in a location that is closely coupled to the tuning fork 116, so that an accurate temperature near the tuning fork 116 can be obtained. The sensor control and processing circuit 118 may then use the temperature obtained from the temperature sensor 117 to process the signals.

Optionally, the tuning fork 116 may include the temperature sensor 117.

Further, the condition data comparison processor 119 will receive the data processed by the sensor control and processing circuit 118, thereby allowing the condition data comparison processor 119 to forward fluid status to the local machine electronics 120 and ultimately to the local machine user interface 122. The local machine user interface 122 may be a display on an automobile, may be a display on a read-out of a machine (analog or digital display), or may be a display of a computer that is local to the machine containing the fluid under-test 114.

Broadly speaking, the sensor control and processing circuit 118 is provided as circuitry that closely communicates with the tuning fork 116 to provide stimulus to the tuning fork, and also receive the response from the tuning fork and process the data received from the tuning fork into appropriate data form to be further processed by the condition data comparison processor 119. In this embodiment, the sensor control and processing circuit 118 is provided in the form of an application-specific integrated circuit (ASIC). Optionally, in this embodiment only, the local machine electronics 120 and the condition data comparison processor 119 may be embodied with the sensor control and processing circuit 118.

For example, the sensor control and processing circuit 118 has the capability of generating a frequency signal that is provided through 111b to the tuning fork, and then is capable of receiving analog signals from the tuning fork over 111a. The analog signals received over 111a are then processed by the sensor control and processing circuit 118 to extract information that will be used to identify characteristics of the fluid under-test 114 by the condition data comparison processor 119.

FIG. 3 illustrates a local machine user interface being used to advantage in accordance with the embodiment of the present invention. The local machine electronics 120, or optionally the condition data comparison processor 119, will therefore communicate with the local machine user interface 122. The user interface may include a user display 122b. The user display 122b may include analog and digital indicators 122d. The analog and digital indicators 122d may indicate the qualities of the fluid under-test (e.g., engine oil), and can be displayed in terms of a gauge reading to indicate to the user when the fluid under-test has degraded or needs to be changed.

In an optional embodiment, the user display 122b may include a digital display 122c (e.g., monitor) that may provide a digital output or display of the condition of the engine oil to the user through an appropriate graphical user interface (GUI). The user interface 122 may also include a user input 122a. The user input 112a may be a electronic interface that would allow a service technician, for example, to provide updated calibration information for a tuning fork that is inserted in a particular vehicle engine, or provide adjusted approximations for new engine oils that may just have come onto the market. By way of the user input 122a or computer port 122e, a service technician may be able to input data or receive data from the condition data comparison processor 119.

FIG. 4 illustrates the condition data comparison processor 119 being used to advantage in accordance with the embodiment of the present invention. The data comparison processor 119 may receive information from any component of the system 100. The condition data comparison processor 119 includes a condition data module 119a, a memory or storage 119b, and a comparison processor 119c. It is recognized that each of these elements may be individually located, or any combination of these elements, within other system 100 components, such as in the fleet maintenance system 103.

The condition data module 119a receives data from the sensor control processor 118 and may store that data into a data field or fluid data sets 101 on the storage 119b. Each fluid data set may be stored upon the storage 119b consistent with methods known in the art for use to advantage with the present invention. Each data set or sets may be retrieved by the comparison processor 119c for analysis. The comparison processor 119c may subsequently store the analyzed data back onto the storage 119b. The analyzed data may be used to advantage as mentioned herein.

FIG. 5 illustrates a diagram for receiving and recording the fluid data received into fluid data sets 101, in accordance with the embodiment of the present invention. The storage 119b stores the fluid data sets 101. Representatively, each data set Dn received from the condition data module 119a may be stored as arranged for concurrent or subsequent analysis by the comparison processor 119c. The present invention is not limited by the representative mode given here for storing data within the storage; moreover any known storage method may be used.

Each data set Dn created and stored by the condition data module 119a may include, without limitation, the sensor signal, sensor data (viscosity, density and dielectric constant), fluid temp, fluid type, fluid parameters, date, time, vehicle identification, vehicle current mileage and a data set identifier. Each time a data set Dn is created the data set Dn may include the most recent information and be indexed (for example D1, D2 . . . ), thereby creating a history that may be used to advantage by the comparison processor 119c in determining the decay or status of the fluid.

The storage 119b may also include storage for additional information, such as a data table of fluid types and ideal fluid parameters for subsequent comparison. The storage 119b may also include for each fluid parameter a set of acceptable ranges or bands of fluid degradation so that the comparison processor 119c may more readily ascertain the current condition or remaining useful life of the fluid. The ranges or bands of fluid degradation may be created for a specific fluid thereby reflecting the affects caused by changes in viscosity, density, dielectric constant, elapsed mileage, fluid age, and fluid temperature, as a few examples without limitation. Bands may be divided in acceptable categories, such as new, ok, or bad. Bands may also be divided in acceptable parameter ranges such as driven mile, engine cycles, sensor output offset (in db), sensor output offset (hz) or time, without limitation. It is anticipated that the bands of fluid degradation will be criteriorized by at least the sensor output offset, but may be criteriorized by any other combination of parameter ranges. These bands of fluid deterioration will necessarily include maximum limits, so that appropriate warnings may be communicated.

Each data set Dn may also indicate whether the fluid was recently changed. The determination of when the oil is changed may be by hard reset or user input at the time of changing. Also, determination of oil changing by the comparison processor 119c may be determined by comparison of the current fluid data together with the known fluid types T stored on the storage 119b. A determined changed fluid condition by the comparison processor 119c may also optionally prompt the user for a confirmation input.

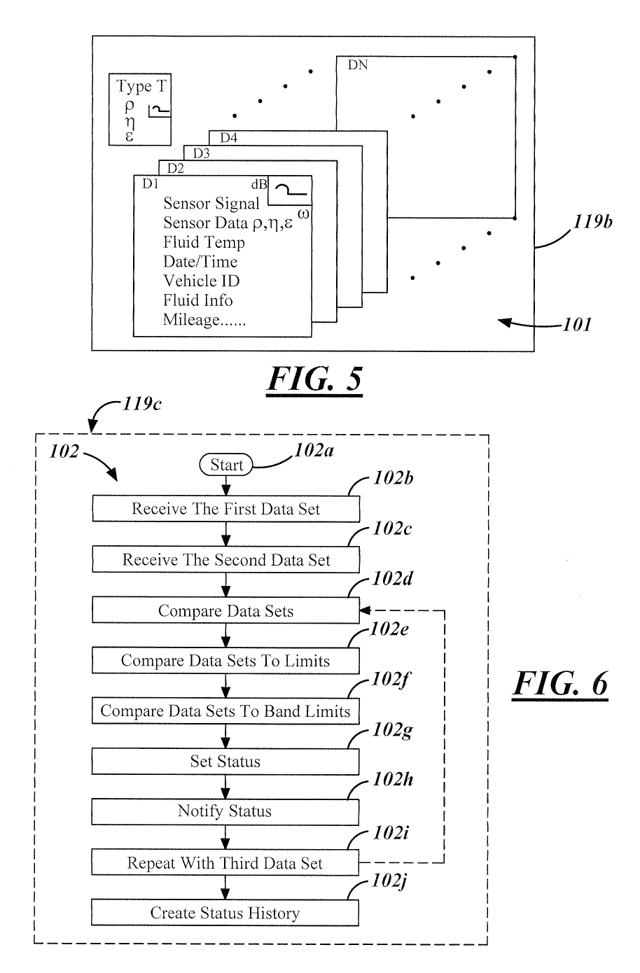

FIG. 6 is a flow chart diagram depicting method performed in the comparison processor 1119c in comparing different fluid data sets Dn, in accordance with the present invention. The comparison processor 119c beings at step 102a by receiving the first data set of interest in step 102b and then receives the second data set of interest in step 102c. In step 102d the data sets of interest are compared to each other to determine the range or band of deterioration. Each band of deterioration may be referenced by a change in viscosity, density, dielectric constant or any other parameter mentioned above. In step 102e or 102f the band of deterioration may be compared to limits or band limits, i.e. a dB or frequency offset in the sensor output data, in determining the condition of the fluid. In step 102g the current fluid condition status is set and optionally stored. In step 102h the user, service technician, or fleet maintenance system is notified of the fluid condition.

Continuing on to step 102i the comparison process may be repeated with each new data set. In step 102j, the fluid condition is stored and a status history is then obtainable from the fluid record being created. The fluid condition and status history enables a user, service technician or fleet maintenance system to advantageously monitor and maintain the automobile without premature expenditure for unnecessary oil changes while ensuring against surpassing the oils degradation or useful limit.

Recapping the above in a most basic configuration, the sensing system of the present invention is configured with a sensor such as a mechanical resonator, a processor and a user interface to inform the user of a level and/or condition of the fluid. In this embodiment, the sensor receives an excitation signal from a signal generator, causing the sensor to resonate. The resonance of the sensor is proportionally related to the viscosity of the fluid, which is directly correlated to the type and present state of the fluid condition. The resulting resonance is transmitted via a generated output signal to a processor, which modifies the signal for analysis and compares it with a known value so as to determine the present state of the fluid. The system then uses the state of the fluid and compares it with prior states of the fluid to ascertain ranges or bands of degradation of the fluid and/or the potential remaining life of the fluid. The degradation of fluid and/or remaining life of the fluid is communicated advantageously for use to a user, service technician or fleet maintenance system.

As used herein, the term processor is not intended to limited to a specific type of device or circuitry, but is intended in its most board sense of being a device capable of performing a function upon an input or output signal. Moreover, two processors having different function need not be different devices, but may be the same device having appropriate functional portions.

As used above, the fluid being sensed has been referred to as a “fluid under-test.” Although specifics are provided with regard to engine oil, as the fluid under-test, it should be understood that any fluid capable of being sensed to ascertain its characteristics (e.g., chemical components or physical attributes) can utilize the teachings defined herein. For instance, the term “fluid” should be broadly construed to include any material in either a liquid form, gas form, a solid form, or a combination of any one of liquid, gas or solid, since all three forms may be present in a fluid such as engine oil.

While the present invention has been described in what is presently considered to be its most practical and preferred embodiment or implementation, it is to be understood that the invention is not to be limited to the disclosed embodiment. On the contrary, the present invention is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A fluid condition detection system comprising:
a fluid sensor selectively used in a fluid of interest;
a sensor control processor for controlling said fluid sensor and generating a fluid condition signal; and
a condition data comparison processor for receiving said fluid condition signal and generating at least one second fluid data set, said condition data comparison processor for possessing said second fluid data set with a first fluid data set for generating a fluid condition status,
whereby said fluid condition status may be communicated to a user, a service technician or a fleet maintenance operator.

2. The fluid condition detection system of claim 1 wherein said fluid of interest is engine motor oil within an oil pan on an automobile.

3. The fluid condition detection system of claim 2 wherein said engine motor oil is 10W-40 motor oil.

4. The fluid condition detection system of claim 1 wherein said fluid sensor is a tuning fork configured to be at least partially submerged in said fluid of interest.

5. The fluid condition detection system of claim 1 further comprising a communication device for transmitting said fluid condition status to an external system.

6. The fluid condition detection system of claim 1 further comprising a communication device for transmitting said at least one second fluid data set to an external system, whereby said external system may process said data sets to obtain said fluid condition status.

7. The fluid condition detection system of claim 1 further comprising a communication device for transmitting said fluid condition signal to said condition data comparison processor, said condition data comparison processor being remotely located from said sensor control processor.

8. The fluid condition detection system of claim 7 wherein said condition data comparison processor is located in a fleet maintenance system and said sensor control processor is located on an automobile.

9. The fluid condition detection system of claim 1 wherein said at least one second fluid data set includes at least one data set identifier and at least one sensor data selected from the group of viscosity, density and dielectric constant.

10. The fluid condition detection system of claim 1 further including a user interface, said user interface including a computer port, whereby said condition data comparison processor may receive data from a service technician processor.

11. The fluid condition detection system of claim 1 wherein said condition data comparison processor is a Azentek mobile processor.

12. The fluid condition detection system of claim 1 wherein said first fluid data set includes a fluid type data set.

13. The fluid condition detection system of claim 1 wherein said fluid condition status includes at least one fluid deterioration indicator, wherein said at least one fluid deterioration indicator is determined from comparison of said fluid data sets with a fluid degradation band reference.

14. The fluid condition detection system of claim 1 wherein said fluid degradation band reference is in offset metrics of hz, db, seconds, or miles, and combinations thereof.

15. The fluid condition detection system of claim 1 wherein said condition data comparison processor includes a condition data module, a storage for storing said at least one second fluid data set or said fluid condition status, and a comparison processor for comparing said second fluid data set with a first fluid data set and for comparing said fluid data sets with a fluid degradation band reference.

16. A system for fluid condition detection and notification comprising:
a fluid sensor in a fluid of interest;
a sensor control processor for controlling said fluid sensor and generating a fluid condition signal;
a condition data comparison processor having a condition data module and a comparison processor, said condition data module for receiving said fluid condition signal and generating at least one second fluid data set, and said comparison processor for possessing said second fluid data set with a first fluid data set for generating a fluid condition status, wherein said comparison processor includes an algorithm comprising:
receiving said first fluid data set;
receiving said second fluid data set;
comparing said data sets; and
setting said fluid condition status; and
a communication device for transmitting said fluid condition to a user interface, a service technician processor or a fleet maintenance system.

17. The system for fluid condition detection and notification of claim 16 said algorithm further comprises comparing said data sets to a parameter limit.

18. The system for fluid condition detection and notification of claim 16 said algorithm further comprises comparing said data sets to a band limit.

19. A method of operating a fluid condition detection system comprising:
monitoring a fluid sensor;
generating a fluid condition signal from said fluid sensor;
generating at least one second fluid data set from said fluid condition signal;
comparing said second fluid data set with at least a first fluid data set obtaining a fluid condition status; and
transmitting said fluid condition status to a user interface, a service technician processor or a fleet maintenance system.

20. A method as recited in claim 19 transmitting said fluid condition status is by a wireless transmitter to said fleet maintenance system, whereby a fleet maintenance operator may ascertain the actual degradation and remaining life of the operating fluid.
